(19) United States
(12) Patent Application Publication
(10) Pub. No.: US 2009/0066277 A1
(43) Pub. Date: Mar. 12, 2009

(54) Voltage Conversion Apparatus and Vehicle Including the Same

(75) Inventors: Wanleng Ang, Aichi-ken (JP); Hichirosai Oyobe, Aichi-ken (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, AICHI-KEN (JP)

(21) Appl. No.: 12/226,996

(22) PCT Filed: May 29, 2007
(86) PCT No.: PCT/JP2007/061258

§ 371 Date: Nov. 4, 2008

(30) Foreign Application Priority Data
Jun. 22, 2006 (JP) 2006-172569

(51) Int. Cl. H02P 4/00

(52) U.S. Cl. 318/400.17; 180/65.21; 903/905

(57) ABSTRACT

Converters are connected in parallel to each other. The converter boosts a voltage from a power storage devices based on a signal from an ECU and outputs the boosted voltage to a capacitor. The converter boosts a voltage from a power storage device based on a signal from the ECU and outputs the boosted voltage to the capacitor. The ECU generates the signals by using carrier signals having phases desynchronized with each other and identical frequencies, and outputs the generated signals to the converters, respectively.

### TECHNICAL FIELD

The present invention relates to a voltage conversion apparatus and a vehicle including the same, and more particularly, to a voltage conversion apparatus including two converters connected in parallel, and a vehicle including the same.

### BACKGROUND ART

Japanese Patent Laying-Open No. 2003-199203 discloses an electric circuit where energy accumulating means is connected between a direct current (DC) source and an inverter with a DC/DC converter interposed therebetween. This electric circuit includes the inverter driving a motor load, a smoothing capacitor suppressing an instantaneous ripple of a DC input voltage of the inverter, the DC source supplying a DC voltage to the inverter, the DC/DC converter connected in parallel to the DC source, and regenerated-energy accumulating means connected to the DC/DC converter.

In this electric circuit, a DC input voltage of the inverter is detected, and when the detected voltage exceeds a set level, a conduction ratio of the DC/DC converter is changed to increase a charging current to the regenerated-energy accumulating means. As a result, the inverter, the DC/DC converter and the regenerated-energy accumulating means are protected.

In the electric circuit disclosed in the above-described Japanese Patent Laying-Open No. 2003-199203, the DC source and the DC/DC converter are connected in parallel, and the regenerated-energy accumulating means is connected to the DC/DC converter. In other words, two DC power supplies are connected in parallel to a DC input of the inverter.

The above-described publication, however, only discloses a technique for protecting the circuit when excessive regenerated energy is supplied from the motor load, and it is not assumed that both of the two DC power supplies connected in parallel are used to supply electric power to the inverter. In other words, in the electric circuit disclosed in the above-described publication, the regenerated-energy accumulating means is used instead of the DC source when electric power supply from the DC source stops or when a voltage thereof is decreased.

On the other hand, in a case where both of the two DC power supplies connected in parallel are used to supply electric power to the inverter, in order to supply a steady voltage, a converter needs to be provided in correspondence with each DC power supply. Where two converters are arranged in parallel with each other, however, consideration must be given to an influence that a ripple of a total current output from the two converters has on the smoothing capacitor provided on an input side of the inverter.

### DISCLOSURE OF THE INVENTION

The present invention was made to solve the above problems and an object thereof is to provide a voltage conversion apparatus that is capable of reducing a current ripple when two converters are connected in parallel.

In addition, another object of the present invention is to provide a vehicle including a voltage conversion apparatus that is capable of reducing a current ripple when two converters are connected in parallel.

According to the present invention, a voltage conversion apparatus includes first and second converters, and a control device generating first and second drive signals and outputting the generated drive signals to the first and second converters, respectively. The first converter converts a voltage from a first power storage device and outputs the converted voltage to a capacitor. The second converter is connected in parallel to the first converter, and converts a voltage from a second power storage device and outputs the converted voltage to the capacitor. The control device generates the first and second drive signals by using first and second carrier waves (carriers) having phases desynchronized with each other and identical frequencies, respectively.

Preferably, a phase of the second carrier wave is different from a phase of the first carrier wave substantially by 180°.

More preferably, the control device includes a carrier wave generating portion, first and second signal generating portions, and a phase inverting portion. The carrier wave generating portion generates the first carrier wave. The first signal generating portion generates the first drive signal based on a first modulated wave for the first converter and the first carrier wave. The phase inverting portion generates the second carrier wave that is phase-inverted with respect to the first carrier wave. The second signal generating portion generates the second drive signal based on a second modulated wave for the second converter and the second carrier wave.

Preferably, a phase of the second carrier wave is adjusted such that a timing of rising of the second drive signal is synchronized with a timing of falling of the first drive signal.

More preferably, the control device includes a carrier wave generating portion, first and second signal generating portions, and a phase adjusting portion. The carrier wave generating portion generates the first carrier wave. The first signal generating portion generates the first drive signal based on a first modulated wave for the first converter and the first carrier wave. The phase adjusting portion generates, based on the first drive signal, the second carrier wave that is phase-adjusted with respect to the first carrier wave such that a timing of rising of the second drive signal is synchronized with a timing of falling of the first drive signal. The second signal generating portion generates the second drive signal based on a second modulated wave for the second converter and the second carrier wave.

Preferably, each of the first and second converters includes a chopper circuit.

In addition, according to the present invention, a vehicle includes any voltage conversion apparatus described above, a drive device, a motor, and a drive wheel. The drive device receives a voltage from a capacitor included in the voltage conversion apparatus. The motor is driven by the drive device. The drive wheel is linked to an output shaft of the motor.

In the present invention, the first and second converters are connected in parallel to each other, and convert a voltage from the corresponding power storage device and output the converted voltage to the capacitor. The control device generates the first and second drive signals by using the first and second carrier waves having phases desynchronized with each other and identical frequencies, respectively, so that a ripple of an output current of the second converter (a second current ripple) is phase-shifted with respect to a ripple of an output current of the first converter (a first current ripple). As a result, peaks of the first and second current ripples are desynchronized and a peak of a ripple of a total current flowing into the capacitor from the first and second converters is suppressed.

Therefore, according to the present invention, the capacitor can have a long life. In addition, the capacitance (size) required by the capacitor can be made appropriate.

### BRIEF DESCRIPTION OF THE DRAWINGS

FIG. 1 is an overall block diagram of a hybrid vehicle represented as an example of a vehicle according to the present invention.

FIG. 2 is a circuit diagram of a configuration of a converter in FIG. 1.

FIG. 3 is a functional block diagram of an ECU in FIG. 1.

FIG. 4 is a functional block diagram of a converter control portion in FIG. 3.

FIG. 5 is a waveform diagram of output currents of the converters.

FIG. 6 is a waveform diagram of output currents of the converters supposing that the converters are controlled by using carrier signals having the same phases.

FIG. 7 is a schematic diagram of the manner in which electromagnetic noise from the converters propagates.

FIG. 8 is a functional block diagram of a converter control portion in a second embodiment.

FIG. 9 is a waveform diagram of output currents of the converters in the second embodiment.

### BEST MODES FOR CARRYING OUT THE INVENTION

The embodiments of the present invention will be described in detail below with reference to the drawings, where the same or corresponding parts are represented by the same reference numerals, and the description thereof will not be repeated.

### First Embodiment

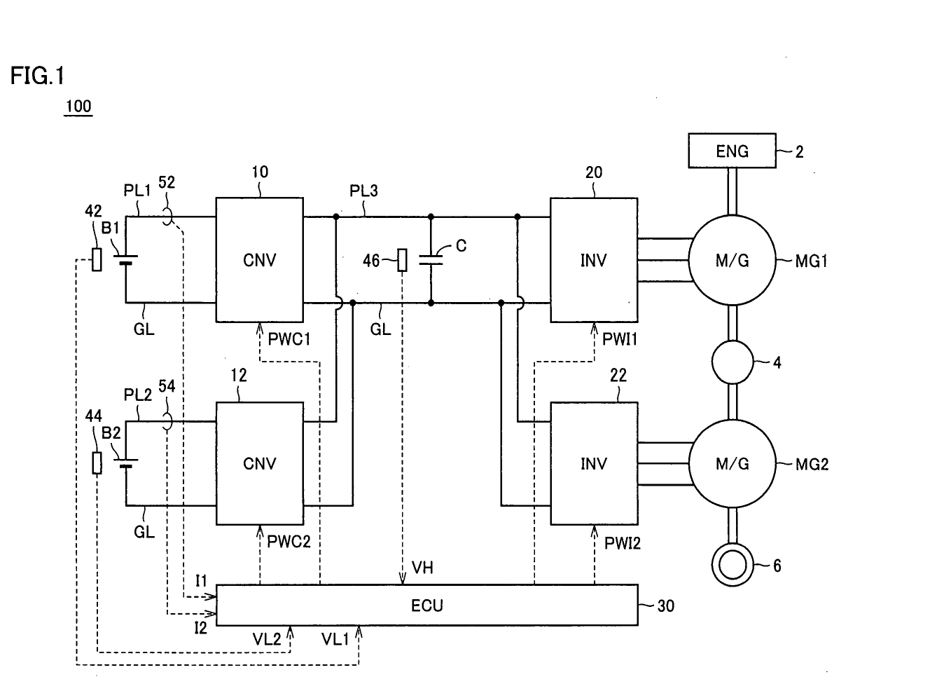

FIG. 1 is an overall block diagram of a hybrid vehicle represented as an example of a vehicle according to the present invention. Referring to FIG. 1, this hybrid vehicle 100 includes an engine 2, motor generators MG1 and MG2, a power split device 4, and wheels 6. Hybrid vehicle 100 further includes power storage devices B1 and B2, converters 10 and 12, a capacitor C, inverters 20 and 22, an ECU (Electronic Control Unit) 30, voltage sensors 42, 44 and 46, and current sensors 52 and 54.

This hybrid vehicle 100 runs by employing engine 2 and motor generator MG2 as a source of motive power. Power split device 4 is coupled to engine 2 and motor generators MG1 and MG2 to distribute motive power therebetween. Power split device 4 is formed of, for example, a planetary gear mechanism having three rotation shafts of a sun gear, a planetary carrier and a ring gear. These three rotation shafts are connected to rotation shafts of engine 4 and motor generators MG1 and MG2, respectively. A rotor of motor generator MG1 is hollowed and a crankshaft of engine 2 passes through the center thereof, so that engine 2 and motor generators MG1 and MG2 are mechanically connected to power split device 4. Furthermore, the rotation shaft of motor generator MG2 is coupled to wheels 6 through a reduction gear or a differential gear that are not shown.

Motor generator MG1 is incorporated into hybrid vehicle 100 as a motor generator operating as a generator driven by engine 2 and operating as a motor that can start up engine 2. Motor generator MG2 is incorporated into hybrid vehicle 100 as a motor that drives wheels 6.

Power storage devices B1 and B2 are chargeable and dischargeable DC power supplies and are formed of, for example, secondary batteries such as nickel-hydride batteries or lithium-ion batteries. Power storage device B1 supplies electric power to converter 10, and is charged by converter 10 during regeneration of electric power. Power storage device B2 supplies electric power to converter 12, and is charged by converter 12 during regeneration of electric power.

For example, a secondary battery whose maximum electric power that can be output is larger than that of power storage device B2 can be used in power storage device B1, and a secondary battery whose power storage capacity is larger than that of power storage device B1 can be used in power storage device B2. As a result, the use of two power storage devices B1 and B2 allows a DC power supply of high power and large capacity to be formed. It should be noted that a capacitor of large capacitance may be used as power storage devices B1 and B2.

Converter 10 boosts a voltage from power storage device B1 based on a signal PWC1 from ECU 30 and outputs the boosted voltage to a power supply line PL3. Furthermore, converter 10 steps down regenerative electric power supplied from inverters 20 and 22 via power supply line PL3 to a voltage level of power storage device B1 based on signal PWC1, and charges power storage device B1.

Converter 12 is connected to power supply line PL3 and a ground line GL in parallel to converter 10. Converter 12 boosts a voltage from power storage device B2 based on a signal PWC2 from ECU 30 and outputs the boosted voltage to power supply line PL3. Furthermore, converter 12 steps down regenerative electric power supplied from inverters 20 and 22 via power supply line PL3 to a voltage level of power storage device B2 based on signal PWC2, and charges power storage device B2.

Capacitor C is connected between power supply line PL3 and ground line GL, and smoothes voltage fluctuations between power supply line PL3 and ground line GL.

Inverter 20 converts a DC voltage from power supply line PL3 into a three-phase alternating current (AC) voltage based on a signal PWI1 from ECU 30 and outputs the converted three-phase AC voltage to motor generator MG1. Furthermore, inverter 20 converts a three-phase AC voltage generated by motor generator MG1 with motive power of engine 2 into a DC voltage based on signal PWI1 and outputs the converted DC voltage to power supply line PL3.

Inverter 22 converts a DC voltage from power supply line PL3 into a three-phase AC voltage based on a signal PWI2 from ECU 30 and outputs the converted three-phase AC voltage to motor generator MG2. Furthermore, during regenerative braking of the vehicle, inverter 22 converts a three-phase AC voltage generated by motor generator MG2 by receiving the rotational force of wheels 6 into a DC voltage based on signal PWI2 and outputs the converted DC voltage to power supply line PL3.

Each of motor generators MG1 and MG2 is a three-phase AC rotating electric machine and is formed of, for example, a three-phase AC synchronous motor generator. Motor generator MG1 is driven to carry out the regenerative operation by inverter 20 and outputs a three-phase AC voltage generated with motive power of engine 2 to inverter 20. Furthermore, at the time of start-up of engine 2, motor generator MG1 is driven to carry out the power running by inverter 20 and cranks up engine 2. Motor generator MG2 is driven to carry out the power running by inverter 22 and generates the driving force for driving wheels 6. Furthermore, during regenerative braking of the vehicle, motor generator MG2 is driven to carry out the regenerative operation by inverter 22 and outputs a three-phase AC voltage generated with the rotational force received from wheels 6 to inverter 22.

Voltage sensor 42 detects a voltage VL1 of power storage device B1 and outputs the detected voltage to ECU 30. Current sensor 52 detects a current I1 output from power storage device B1 to capacitor 10 and outputs the detected current to ECU 30. Voltage sensor 44 detects a voltage VL2 of power storage device B2 and outputs the detected voltage to ECU 30. Current sensor 54 detects a current I2 output from power storage device B2 to capacitor 12 and outputs the detected current to ECU 30. Voltage sensor 46 detects a voltage across the terminals of capacitor C, that is, a voltage VH of power supply line PL3 with respect to ground line GL, and outputs the detected voltage VH to ECU 30.

ECU 30 generates signals PWC1 and PWC2 for driving converters 10 and 12, respectively, and outputs the generated signals PWC1 and PWC2 to converters 10 and 12, respectively. Furthermore, ECU 30 generates signals PWI1 and PWI2 for driving inverters 20 and 22, respectively, and outputs the generated signals PWI1 and PWI2 to inverters 20 and 22, respectively.

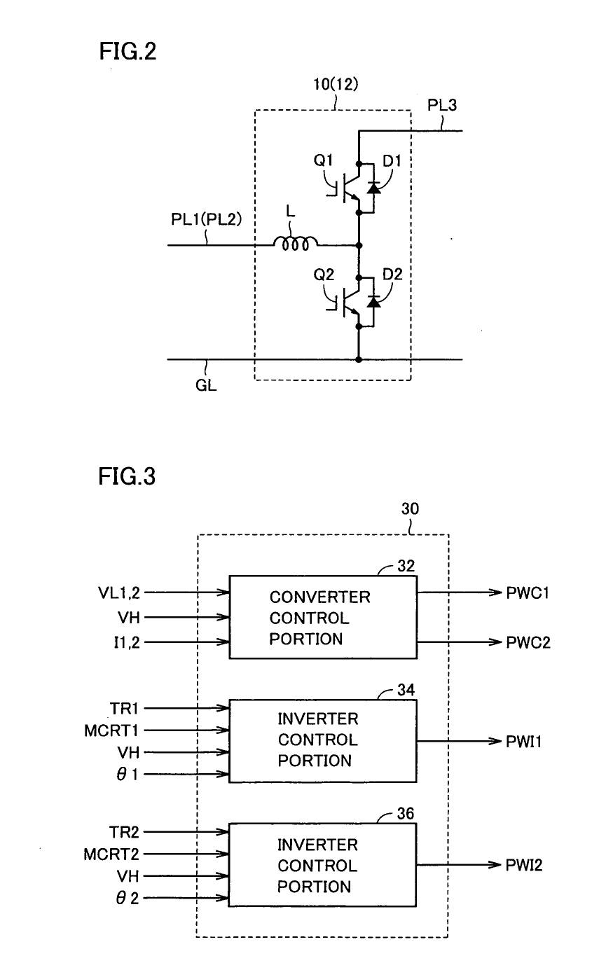

FIG. 2 is a circuit diagram of a configuration of converter 10 or 12 in FIG. 1. Referring to FIG. 2, converter 10 (12) includes npn-type transistors Q1 and Q2, diodes D1 and D2, and a reactor L. Npn-type transistors Q1 and Q2 are connected in series between power supply line PL3 and ground line GL. Diodes D1 and D2 are connected in antiparallel to npn-type transistors Q1 and Q2, respectively. Reactor L has one end connected to a connection node of npn-type transistors Q1 and Q2, and the other end connected to power supply line PL1 (PL2). It should be noted that an IGBT (Insulated Gate Bipolar Transistor), for example, can be used as the above-described npn-type transistors.

This converter 10 (12) is formed of a chopper circuit. Converter 10 (12) boosts a voltage of power supply line PL1 (PL2) using reactor L and outputs the boosted voltage to power supply line PL3, based on signal PWC1 (PWC2) from ECU 30 (not shown).

Specifically, converter 10 (12) stores in reactor L a current flowing when npn-type transistor Q2 is turned on as magnetic field energy, so that converter 10 (12) boosts a voltage of power supply line PL1 (PL2). Converter 10 (12) outputs the boosted voltage to power supply line PL3 via diode D1 in synchronization with the timing when npn-type transistor Q2 is turned off.

FIG. 3 is a functional block diagram of ECU 30 in FIG. 1. Referring to FIG. 3, ECU 30 includes a converter control portion 32 and inverter control portions 34 and 36.

Converter control portion 32 generates a PWM (Pulse Width Modulation) signal for turning on/off npn-type transistors Q1 and Q2 of converter 10 based on voltage VL1 from voltage sensor 42, voltage VH from voltage sensor 46 and current I1 from current sensor 52, and outputs the generated PWM signal to converter 10 as signal PWC1.

Furthermore, converter control portion 32 generates a PWM signal for turning on/off npn-type transistors Q1 and Q2 of converter 12 based on voltage VL2 from voltage sensor 44, voltage VH and current I2 from current sensor 54, and outputs the generated PWM signal to converter 12 as signal PWC2.

Inverter control portion 34 generates a PWM signal for turning on/off a power transistor included in inverter 20 based on a torque command TR1, a motor current MCRT1 and a rotation angle θ1 of the rotor of motor generator MG1 as well as voltage VH, and outputs the generated PWM signal to inverter 20 as signal PWI1.

Inverter control portion 36 generates a PWM signal for turning on/off a power transistor included in inverter 22 based on a torque command TR2, a motor current MCRT2 and a rotation angle θ2 of a rotor of motor generator MG2 as well as voltage VH, and outputs the generated PWM signal to inverter 22 as signal PWI2.

It should be noted that torque commands TR1 and TR2 are calculated by a not-shown external ECU based on, for example, an accelerator opening degree, an amount that the brake is pressed, a vehicle speed, or the like. Each of motor currents MCRT1 and MCRT2 as well as rotation angles θ1 and θ2 of the rotors is detected by a not-shown sensor.

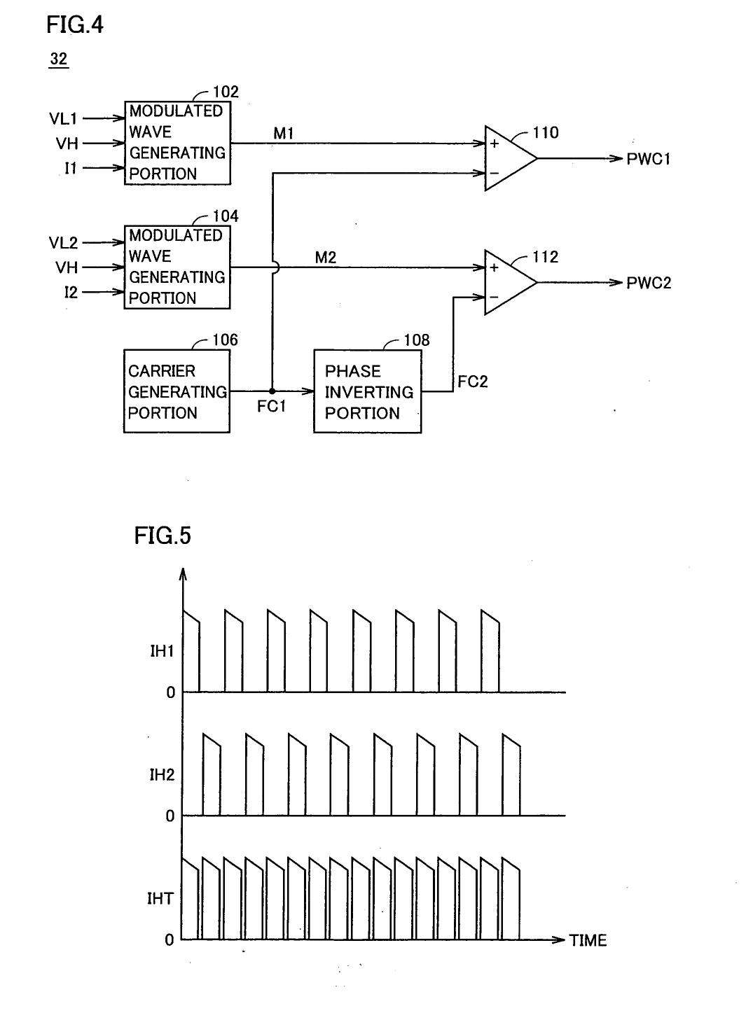

FIG. 4 is a functional block diagram of converter control portion 32 in FIG. 3. Referring to FIG. 4, converter control portion 32 includes modulated wave generating portions 102 and 104, a carrier generating portion 106, a phase inverting portion 108, and comparators 110 and 112.

Modulated wave generating portion 102 generates a modulated wave M1 corresponding to converter 10 based on voltages VL1 and VH and/or current I1. Modulated wave generating portion 104 generates a modulated wave M2 corresponding to converter 12 based on voltages VL2 and VH and/or current I2. Modulated wave generating portions 102 and 104 can generate modulated waves M1 and M2 such that input currents and output voltages of the corresponding converters are controlled to target values. For example, modulated wave generating portion 102 can generate a modulated wave based on current I1 such that current I1 supplied from power storage device B1 to converter 10 is controlled to a prescribed target value, and modulated wave generating portion 104 can generate modulated wave M2 based on voltages VL2 and VH such that voltage VH is controlled to a prescribed target value.

Carrier generating portion 106 generates a carrier signal FC1 for generating signal PWC1 that is a PWM signal. Carrier signal FC1 has triangular waves and a cycle thereof is set in consideration of a switching loss of converters 10 and 12.

Phase inverting portion 108 receives carrier signal FC1 from carrier generating portion 106 and outputs a carrier signal FC2 that is phase-shifted by 180° with respect to carrier signal FC1.

Comparator 110 compares modulated wave M1 from modulated wave generating portion 102 with carrier signal FC1 from carrier generating portion 106, and generates signal PWC1 that changes depending on whether modulated wave M1 is larger or smaller than carrier signal FC1. Comparator 112 compares modulated wave M2 from modulated wave generating portion 104 with carrier signal FC2 from phase inverting portion 108, and generates signal PWC2 that changes depending on whether modulated wave M2 is larger or smaller than carrier signal FC2.

In this converter control portion 32, signal PWC1 is generated based on carrier signal FC1 and signal PWC2 is generated based on carrier signal FC2 that is phase-shifted by 180° with respect to carrier signal FC1. As a result, a ripple of an output current of converter 12 is 180° out of phase with respect to a ripple of an output current of converter 10.

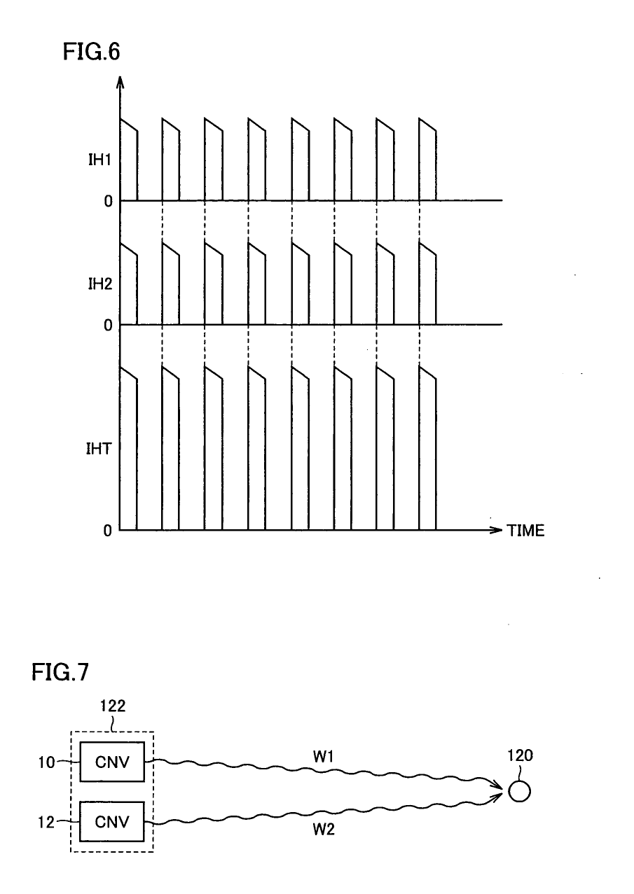

FIG. 5 is a waveform diagram of output currents of converters 10 and 12. FIG. 6 is a waveform diagram of output currents of converters 10 and 12 supposing that converters 10 and 12 are controlled by using carrier signals having the same phases. It should be noted that FIG. 6 is shown by way of comparison in order to describe the effects of the present invention.

Referring to FIGS. 5 and 6, currents IH1 and IH2 indicate output currents of converters 10 and 12, respectively. A current IHT indicates a total value of currents IH1 and IH2, that is, a total current supplied from two converters 10 and 12 to capacitor C.

As shown in FIG. 6, in a case where converters 10 and 12 are controlled by using carrier signals having the same phases, a peak of current IH1 is superimposed on a peak of current IH2 and a ripple of total current IH1 is increased.

On the other hand, in the present first embodiment, converters 10 and 12 are controlled by using the carrier signals that are phase-shifted by 180° with respect to each other as described above. Therefore, as shown in FIG. 5, a peak of current IH1 is 180° out of phase with respect to a peak of current IH2. As a result, a ripple of total current IHT is suppressed as compared to that of FIG. 6.

If the boost ratios of converters 10 and 12 are low, a portion where currents IH1 and IH2 may partially be superimposed on each other may be created. In such a case, however, it is assumed that absolute values of the currents are small, and therefore, this presents no problem.

In converters 10 and 12, reactor L vibrates due to a switching operation of npn-type transistors Q1 and Q2 and electromagnetic noise dependent on a carrier frequency is generated. As described above, however, where converters 10 and 12 are controlled by using the carrier signals that are phase-shifted by 180° with respect to each other, noise from overall converters 10 and 12 can be reduced.

FIG. 7 is a schematic diagram of the manner in which electromagnetic noise from converters 10 and 12 propagates. Referring to FIG. 7, in a case where sound waves W1 and W2 from converters 10 and 12 propagate to an occupant 120 in the vehicle, converters 10 and 12 can be considered as one sound source 122 because the distance between converters 10 and 12 is shorter than the distance between converters 10 and 12 and occupant 120.

Here, as converters 10 and 12 are controlled by using the carrier signals that are phase-shifted by 180° with respect to each other, a phase difference between sound waves W1 and W2 is 180° and sound waves W1 and W2 cancel each other out in the position of occupant 120. Therefore, noise from overall converters 10 and 12 can be reduced.

As described above, in the present first embodiment, carrier signal FC2 that is phase-shifted by 180° with respect to carrier signal FC1 is generated and carrier signals FC1 and FC2 are used to generate signals PWC1 and PWC2, respectively. Therefore, the ripple of the output current of converter 12 is phase-shifted by 180° with respect to the ripple of the output current of converter 10. As a result, the peak of the ripple of the output current of each of converters 10 and 12 is shifted and the peak of the ripple of total current IHT flowing into capacitor C from converters 10 and 12 is suppressed.

Therefore, according to the present first embodiment, capacitor C can have a long life. In addition, the capacitance (size) required by capacitor C can be reduced.

Furthermore, phases of sound waves W1 and W2 generated from converters 10 and 12 are also inverted, so that noise from overall converters 10 and 12 can be reduced.

### Second Embodiment

Although carrier signal FC2 for converter 12 is phase-shifted by 180° with respect to carrier signal FC1 for converter 10 in the first embodiment, a phase difference between carrier signals FC1 and FC2 does not necessarily have to be 180°.

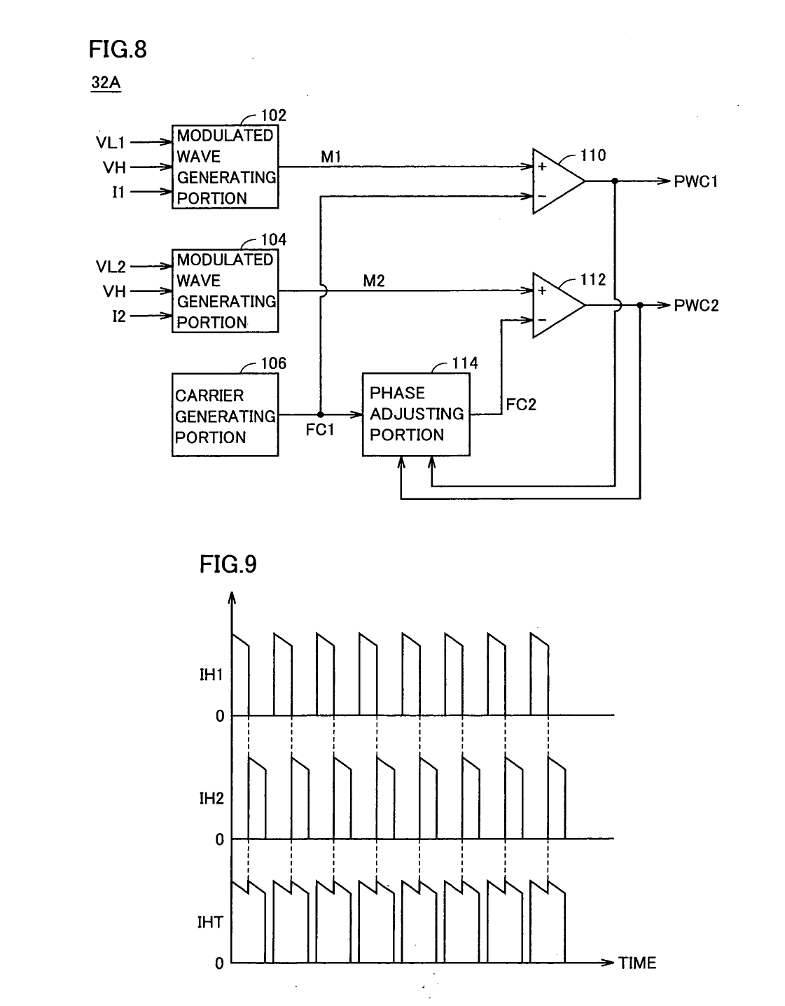

FIG. 8 is a functional block diagram of a converter control portion in a second embodiment. Referring to FIG. 8, this converter control portion 32A includes a phase adjusting portion 114 instead of phase inverting portion 108 in a configuration of converter control portion 32 in the first embodiment shown in FIG. 4.

Phase adjusting portion 114 receives carrier signal FC1 from carrier generating portion 106 as well as signals PWC1 and PWC2 output from comparators 110 and 112, respectively. Phase adjusting portion 114 outputs carrier signal FC2 that is phase-adjusted with respect to carrier signal FC1 such that a timing of rising of signal PWC2 is synchronized with a timing of falling of signal PWC1.

It should be noted that the configuration of converter control portion 32A is otherwise the same as that of converter control portion 32.

In this converter control portion 32A, carrier signal FC2 is phase-adjusted with respect to carrier signal FC1 such that a timing of rising of signal PWC2 is synchronized with a timing of falling of signal PWC1. As a result, a ripple of an output current of converter 12 is out of phase with respect to a ripple of an output current of converter 10, and a ripple current from converter 10 and a ripple current from converter 12 are continuous in part.

FIG. 9 is a waveform diagram of output currents of converters 10 and 12 in the second embodiment. Referring to FIG. 9, currents IH1 and IH2 indicate output currents of converters 10 and 12, respectively. Current IHT indicates a total value of currents IH1 and IH2, that is, a total current supplied from two converters 10 and 12 to capacitor C.

As described above, a timing of rising of signal PWC2 is synchronized with a timing of falling of signal PWC1, so that a timing of rising of current IH2 is synchronized with a timing of falling of current IH1. Therefore, current IH2 flows continuously after current IH1 flows. As a result, a ripple frequency of total current IHT is reduced by half as compared to that in the first embodiment shown in FIG. 5.

Although a phase difference between carrier signals FC1 and FC2 is adjusted such that a timing of rising of signal PWC2 is synchronized with a timing of falling of signal PWC1 in the above, a phase difference between carrier signals FC1 and FC2 may be adjusted such that a timing of rising of signal PWC1 is synchronized with a timing of falling of signal PWC2.

As described above, in the present second embodiment, the phase difference between carrier signals FC1 and FC2 is adjusted such that a timing of rising of signal PWC2 is synchronized with a timing of falling of signal PWC1, so that current IH1 from converter 10 and current IH2 from converter 12 are made continuous in part. As a result, the ripple frequency of total current IHT is reduced by half as compared to that in the first embodiment.

Therefore, according to the present second embodiment, an influence that the ripple by converters 10 and 12 has on capacitor C can further be reduced as compared to that in the first embodiment.

In the above-described first and second embodiments, a so-called series/parallel-type hybrid vehicle has been described, in which motive power of engine 2 is distributed into motor generator MG1 and wheels 6 by employing power split device 4. The present invention, however, is also applicable to a so-called series-type hybrid vehicle using motive power of engine 2 only for electric power generation by motor generator MG1 and generating the driving force of the vehicle by employing only motor generator MG2.

In addition, the present invention is also applicable to an electric vehicle that runs with only electric power without having engine 2, or a fuel cell vehicle that further includes a fuel cell as a power source.

In the above, converters 10 and 12 correspond to “a first converter” and “a second converter” in the present invention, respectively, and power storage devices B1 and B2 correspond to “a first power storage device” and “a second power storage device” in the present invention, respectively. ECU 30 corresponds to “a control device” in the present invention, and carrier generating portion 106 corresponds to “a carrier wave generating portion” in the present invention. Furthermore, comparators 110 and 112 correspond to “a first signal generating portion” and “a second signal generating portion” in the present invention, respectively. In addition, inverters 20 and 22 form “a drive device” in the present invention, and motor generators MG1 and MG2 correspond to “motors” in the present invention.

It should be understood that the embodiments disclosed herein are illustrative and not limitative in any respect. The scope of the present invention is defined by the terms of the claims, rather than the description above, and is intended to include any modifications within the scope and meaning equivalent to the terms of the claims.

1. A voltage conversion apparatus, comprising:
a first converter converting a voltage from a first power storage device and outputting the converted voltage to a capacitor;
a second converter connected in parallel to said first converter, and converting a voltage from a second power storage device and outputting the converted voltage to said capacitor; and
a control device generating first and second drive signals by using first and second carrier waves having phases desynchronized with each other and identical frequencies, respectively, and outputting the generated first and second drive signals to said first and second converters, respectively.

2. The voltage conversion apparatus according to claim 1, wherein
a phase of said second carrier wave is different from a phase of said first carrier wave substantially by 180°.

3. The voltage conversion apparatus according to claim 2, wherein
said control device includes
a carrier wave generating portion generating said first carrier wave,
a first signal generating portion generating said first drive signal based on a first modulated wave for said first converter and said first carrier wave,
phase inverting portion generating said second carrier wave that is phase-inverted with respect to said first carrier wave, and
a second signal generating portion generating said second drive signal based on a second modulated wave for said second converter and said second carrier wave.

4. The voltage conversion apparatus according to claim 1, wherein
a phase of said second carrier wave is adjusted such that a timing of rising of said second drive signal is synchronized with a timing of falling of said first drive signal.

5. The voltage conversion apparatus according to claim 4, wherein
said control device includes
a carrier wave generating portion generating said first carrier wave,
a first signal generating portion generating said first drive signal based on a first modulated wave for said first converter and said first carrier wave,
a phase adjusting portion generating, based on said first drive signal, said second carrier wave that is phase-adjusted with respect to said first carrier wave such that a timing of rising of said second drive signal is synchronized with a timing of falling of said first drive signal, and
a second signal generating portion generating said second drive signal based on a second modulated wave for said second converter and said second carrier wave.

6. The voltage conversion apparatus according to claim 1, wherein
each of said first and second converters includes a chopper circuit.

7. A vehicle, comprising:
first and second power storage devices;
a first converter converting a voltage from said first power storage device and outputting the converted voltage to a capacitor;
a second converter connected in parallel to said first converter, and converting a voltage from said second power storage device and outputting the converted voltage to said capacitor;
a control device generating first and second drive signals by using first and second carrier waves having phases desynchronized with each other and identical frequencies, respectively, and outputting the generated first and second drive signals to said first and second converters, respectively;
a drive device receiving a voltage from said capacitor;
a motor driven by said drive device; and
a drive wheel linked to an output shaft of said motor.
